(19) United States
(12) Patent Application Publication
(10) Pub. No.: US 2007/0113001 A1
(43) Pub. Date: May 17, 2007

(54) Semiconductor processor and semiconductor integrated circuit

(75) Inventor: Nobuaki Yamada, Tokyo (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/599,264

(22) Filed: Nov. 15, 2006

(30) Foreign Application Priority Data
Nov. 16, 2005 (JP) 2005-331334

(51) Int. Cl. G06F 12/00; G06F 12/16

(52) U.S. Cl. 711/103; 711/162

(57) ABSTRACT

The present invention is directed to shorten time required to backup stored information to be erased in a nonvolatile memory. A nonvolatile memory has a plurality of memory mats on which a rewriting operation can be performed on a page unit basis, and a memory control circuit capable of performing a byte access control on the memory mats. The memory control circuit makes a plurality of memory mats operate in the byte access control, at the time of rewriting data, merges data read from a selected page in one memory mat with write byte data, writes the resultant data to a corresponding page selected in the other memory mats and, at the time of reading, reads the data from the valid page which is most recently rewritten selected in the plurality of memory mats. The selected page in one memory mat has substantial backup data which has not been subjected to the rewriting for a selected page in another memory mat.

### CROSS-REFERENCE TO RELATED APPLICATION

The present application claims priority from Japanese patent application No. 2005-331334 filed on Nov. 16, 2005, the content of which is hereby incorporated by reference into this application.

### BACKGROUND OF THE INVENTION

The present invention relates to a semiconductor integrated circuit having a rewritable nonvolatile memory, and a semiconductor processor having a rewritable nonvolatile memory and a data processing unit capable of accessing the nonvolatile memory. The invention relates to a technique effectively applied to, for example, a microcomputer for an IC card or the like.

Japanese Unexamined Patent Publication No. Sho 63-266698 describes a microcomputer for an IC card, having a CPU and an EEPROM and using the EEPROM for both of a data area and a program area. Japanese Unexamined Patent Publication No. Hei 05-266219 describes a microcomputer in which an electrically rewritable flash memory and a CPU are provided on a chip. International Publication WO 2004-023385 describes a microcomputer for an IC card having a flash memory and an EEPROM having the same memory cell configuration. The EEPROM and the flash memory used as a data storing area in the microcomputer are requested to rewrite data within required time from the viewpoint of data processing. The EEPROM and the flash memory are similarly constructed using electrically erasable and programmable nonvolatile memory cells. The EEPROM is constructed in such a manner that well regions in the nonvolatile memory cells are electrically isolated on the byte unit basis as the erasing/writing unit. With the configuration, byte-unit erasing is performed by applying a high-voltage across the well region and the control gate, and byte-unit writing is performed by applying a high voltage across the drain and the control gate. The erasing/writing operation is not performed on byte data which is not to be erased/written. On the other hand, in the flash memory, wells are not isolated on the byte unit basis. By applying a high voltage across the well region and the control gate on the page unit basis, that is, the word line unit basis, batch erasure on the word line unit basis is performed. The writing operation is performed by applying a high voltage to the control gate on the word line unit basis. Therefore, in the case of rewriting byte data in the flash memory, stored information of one word line to be rewritten is saved in a data latch, and batch erasure is performed on the word line unit basis. After that, byte data to be rewritten on the data latch is replaced with write byte data from the outside, and the writing on the word line unit basis is performed using the replaced one word line.

### SUMMARY OF THE INVENTION

The inventors of the present invention have examined a method of replacing the EEPROM with a flash memory. Specifically, since the well regions in the nonvolatile memory cells are isolated on the byte unit basis in the EEPROM, rewriting on the byte unit basis can be directly performed, but the chip area increases. Consequently, by employing a flash memory in which well regions are not isolated on the byte unit basis, reduction in the chip area by about 40% or increase in the storage capacity was intended. However, to rewrite data on the byte unit basis in a flash memory in which the erasing/writing unit is a page unit, for example, a word line unit, it is necessary to suppress undesirable destruction of data saved in the data latch on the word line unit basis before erasure due to shutoff of the operation power supply or the like. Therefore, an operation of making a temporary backup of the saved data in a nonvolatile memory area has to be performed. If the operation is performed by software of the CPU each time data is rewritten, rewriting operation time becomes too long. For example, in applications such as a microcomputer for an IC card used for a card device for performing a non-contact interface, rewriting of the flash memory or the like has to be performed within the limited non-contact interface time, so that increase in the speed of operation is requested.

An object of the present invention is to provide a semiconductor processor and a semiconductor integrated circuit realizing shortening of time required to make a backup of storage information to be erased in a nonvolatile memory.

The above and other objects and novel features of the present invention will become apparent from the description of the specification and the appended drawings.

Outline of representative ones of inventions disclosed in the application will be briefly described as follows.

[1] A semiconductor integrated circuit (1) according to the present invention includes a rewritable nonvolatile memory (6) and a data processing unit (2) capable of accessing the nonvolatile memory. The nonvolatile memory has a plurality of memory mats (21 and 22) on which a rewriting operation can be performed on a page unit basis, and a memory control circuit (26, 37, and 38) for controlling a storing operation on the memory mats in response to an access instruction from the data processing unit. The memory control circuit performs a byte access control in response to an access to a predetermined address area in the memory mats and performs a page access control in response to an access to the other address areas. The memory control circuit reads control information of each of pages of the plurality of memory mats in the byte access control, determines a page which is rewritten most recently from valid pages on the basis of the read control information, at the time of rewriting data, merges data read from the determined page with write data in a byte unit, writes the resultant data to a corresponding page selected in the other memory mats and, at the time of reading, reads the data from the determined page.

With the means, in the data rewriting operation by the byte access control, data other than a byte to be rewritten is stored as it is in a valid page which is selected and rewritten most recently in one memory mat, and page data in which a byte to be rewritten is updated is newly written in a selected page in another memory mat. Therefore, the selected page in one memory mat has substantial backup data which has not been subjected to rewriting for the selected page in the other memory mat. It is unnecessary to add another access operation for transferring data to another area for backup. Whether the page is a backup page or normal page in the reading operation is distinguished by determining whether the page is the most recently rewritten page or not on the basis of control information of each page.

As a concrete mode of the invention, a plurality of error determination bits (PDS2, PDS3) for indicating whether data of the page is destroyed or not are included as the control information. The memory control circuit determines validity of the selected page by the error determination bits of the page.

As a further another concrete mode of the invention, the error determination bits have a combination of a plurality of different logic values. It is considered that if data destruction occurs due to power shutoff during erasing or writing operation, the plurality of error determination bits have the same logic value of 0 or 1.

As a further another concrete mode of the invention, the memory control circuit does not require validity of the corresponding page to which the merged data is written.

As a further another concrete mode of the invention, priority data (PDS0, PDS1) of a plurality of bits for indicating priority of data of the page is provided as the control information. The control circuit determines that a page corresponding to priority data having the highest priority is a page which is rewritten most recently.

As a further another concrete mode of the invention, at the time of writing the data obtained by merging the byte data, the memory control circuit updates priority data of a page to be written so as to have priority higher than that of a page having the original data which was merged with the byte data. It facilitates the operation of updating priority data so that whether the page is the most recently rewritten page or not can be determined.

As a further another concrete mode of the invention, the predetermined address area on which the byte access control is to be performed is set as a data storing area, and the other address area on which the page access control is to be performed is set as a program storing area. It is necessary to satisfy requirement of a high-speed access even in the writing operation for a data access. However, with respect to a program, there are hardly any circumstances that a program has to be rewritten at high speed during data process. In consideration of the fact, priority is placed on increase in program memory capacity or address mapping capacity.

As a further another concrete mode of the invention, the predetermined address area on which the byte access control is to be performed is set as a first data storing area, and the other address area on which the page access control is to be performed is set as a second data storing area. The address mapping capacity with respect to the number of memory cells in the first data area is reduced to the half of the second data area. However, the maximum rewriting assuring times in the first data area becomes twice as large as that in the second data area.

As a further another concrete mode o the invention, the memory control circuit has an address controller (37). The address controller receives an access address signal (ADRS) supplied from the data processing unit and, in response to the received access address signal, generates a page selection address (XADRS) for selecting a page, a byte selection address (YADRS) for selecting a byte in the page, and mat selection control signals (MC1, MC2) of two bits. The address controller generates a page address common to two memory mats in response to the access address signal designating the page access control, sets the mat selection control signal to a first or second value in accordance with the value of predetermined one bit in the access address signal, generates a page address common to the two memory mats in response to the access address signal designating the byte access control, and sets the mat selection control signals to a third or fourth value on the basis of other control information. When the mat selection control signals have the third value, the memory control circuit reads data from a page determined as a page rewritten most recently.

The other control information is, for example, control information for selectively setting a test mode. As a further another concrete mode, when the mat selection control signal has the fourth value, the memory control circuit reads data from a page different from the determined page. Page data on the backup side, which is not read to the outside, can be used for a test operation such as verification.

As a further another concrete mode of the invention, a predetermined address area in a memory mat on which the byte access control is to be performed is an area which is divided to an inaccessible area and an accessible area. In correspondence with the arrangement, a decode logic for decoding the address signal (XADRS) for performing page selection has to change the address signal to address information which is smaller than a decode logic only for a page access by one bit. Accordingly, the address control circuit (37) has to delete one bit from address bits on the high-order side at the time of extracting a necessary address signal (XADRS) from the access address signal ADRS from the CPU or the like.

As another mode, a predetermined address area in a memory mat on which the byte access control is to be performed may be an area in which inaccessible areas and accessible areas are alternately disposed in each page. In this case, the decode logic for decoding the address signal (XADRS) for performing page selection may be the same as the decode logic only for a page address. It is sufficient for the address control circuit to simply extract a necessary address signal from the high-order side of the access address signal from the CPU or the like, and to output the extracted signal. From this viewpoint, a register for setting the data storing area is provided in the address control circuit, and the data storing area can be set by rewriting the value of the register by software.

[2] A semiconductor processor according to another aspect of the invention has a rewritable nonvolatile memory and a data processing unit capable of accessing the nonvolatile memory. The nonvolatile memory has a plurality of memory mats on which a rewriting operation can be performed on a page unit basis, and a memory control circuit capable of performing a byte access control on the memory mats in response to an access instruction from the data processing unit. The memory control circuit reads control information of each of pages of a plurality of memory mats in the byte access control, determines a page which is rewritten most recently among valid pages on the basis of the read control information, at the time of rewriting data, merges data read from the determined page with write data in a byte unit, writes the resultant data to a corresponding page selected in the other memory mats and, at the time of reading, reads the data from the determined page.

With the means, in the data rewriting operation by the byte access control, data other than a byte to be rewritten is stored as it is in a valid page which is selected and rewritten most recently in one memory mat, and page data in which a byte to be rewritten is updated is newly written in a selected page in another memory mat. Therefore, the selected page in one memory mat has substantial backup data which has not been subjected to rewriting for the selected page in the other memory mat. It is unnecessary to add another access operation for transferring data to another area for backup. Whether the page is a backup page or normal page in the reading operation is distinguished by determining whether the page is the most recently rewritten page or not on the basis of control information of each page.

[3] A semiconductor integrated circuit according to another aspect of the invention has a rewritable nonvolatile memory. The nonvolatile memory has a plurality of memory mats on which a rewriting operation can be performed on a page unit basis, and a memory control circuit performing a byte access control on the memory mats in response to an access instruction from the outside. The memory control circuit reads control information of each of pages of the plurality of memory mats in the byte access control, determines a page which is rewritten most recently among valid pages on the basis of the read control information, at the time of rewriting data, merges data read from the determined page with write data in a byte unit, writes the resultant data to a corresponding page selected in the other memory mats and, at the time of reading, reads the data from the determined page.

In a manner similar to the above, in the data rewriting operation by the byte access control, data other than a byte to be rewritten is stored as it is in a valid page which is selected and rewritten most recently in one memory mat, and page data in which a byte to be rewritten is updated is newly written in a selected page in another memory mat. Therefore, the selected page in one memory mat has substantial backup data which has not been subjected to rewriting for the selected page in the other memory mat.

[4] A semiconductor integrated circuit according to another aspect of the invention has a rewritable nonvolatile memory. The nonvolatile memory has a plurality of memory mats on which a rewriting operation can be performed on a page unit basis, and a memory control circuit performing a byte access control on the memory mats in response to an access instruction from the outside. The memory control circuit makes a plurality of memory mats operate in the byte access control, at the time of rewriting data, merges data read from a selected page in one memory mat with write byte data, writes the resultant data to a corresponding page selected in the other memory mats and, at the time of reading, reads the data from the valid page which is most recently rewritten in the selected pages in the plurality of memory mats.

In a manner similar to the above, in the data rewriting operation by the byte access control, data other than a byte to be rewritten is stored as it is in a page which is selected in one memory mat, and page data in which a byte to be rewritten is updated is newly written in a selected page in another memory mat. Therefore, the selected page in one memory mat has substantial backup data which has not been subjected to rewriting for the selected page in the other memory mat.

Effects obtained by the representative ones of the inventions disclosed in the application will be briefly described as follows.

The time required to make a backup copy of stored information to be erased in a nonvolatile memory can be shortened.

At the time of erasing/rewriting a nonvolatile memory, by selecting any one of a plurality of memory mats and performing erasing and rewriting operations, the load on a high-voltage charge pump can be reduced, and power consumption and the area of a voltage generating circuit (VPPG) can be reduced.

### BRIEF DESCRIPTION OF THE DRAWINGS

FIG. 1 is a block diagram illustrating a flash memory to be mounted on a microcomputer.

FIG. 2 is a block diagram illustrating a microcomputer according to an example of a semiconductor processor of the invention.

FIG. 3 is a block diagram showing a microcomputer having a non-contact interface.

FIG. 4 shows an address map of a flash memory.

FIG. 5 is a diagram showing significance of mat control signals MC1 and MC2.

FIG. 6 is a diagram showing a concrete example of a page data status.

FIG. 7 is a flowchart showing an outline of a control mode by a mat control circuit according to the page data status.

FIG. 8 is a flowchart showing the flow of data in byte reading operation on a page access area.

FIG. 9 is a flowchart showing the flow of data in byte reading operation on a byte access area.

FIG. 10 is a flowchart showing the flow of data in page writing operation on the page access area.

FIG. 11 is a flowchart showing the flow of data in data reading operation for merging page data to be rewritten in the byte rewriting operation on the byte access area with write byte data.

FIG. 12 is a flowchart showing the flow of data in the writing operation on page data merged in the byte rewriting operation on the byte access area.

FIG. 13 shows another address map of a flash memory.

FIG. 14 is a diagram illustrating significance of the mat control signals MC1 and MC2 corresponding to the address map of FIG. 13.

### DETAILED DESCRIPTION OF PREFERRED EMBODIMENTS

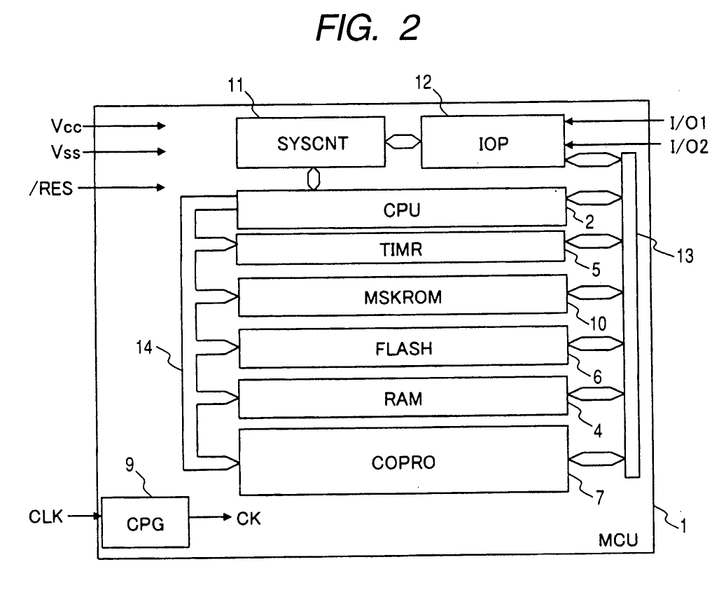

FIG. 2 is a block diagram of a microcomputer according to an example of a semiconductor processor of the invention. A microcomputer (MCU) 1 shown in the diagram is, although not limited, a microcomputer for an IC card (so-called IC card microcomputer). The microcomputer 1 shown in the diagram is formed by providing a CMOS and the like on a single semiconductor substrate made of single crystal silicon or the like, or a semiconductor chip by the semiconductor integrated circuit manufacturing technique.

The microcomputer 1 has a central processing unit (CPU) 2, a random access memory (RAM) 4, a timer (TIMR) 5, a flash memory (FLASH) 6, a coprocessor (COPRO) 7, a clock generator (CPG) 9, a mask ROM (MSKROM) 10, a system control logic (SYSCNT) 11, an input/output port (IOP) 12, a data bus 13, and an address and control bus 14.

The mask ROM 10 is used to store a program (operation program) to be executed by the CPU 2. The flash memory 6 is used for storing the operation program of the CPU 2 and storing data used by a computing process in the CPU 2. The RAM 4 serves as a work area of the CPU 2 or a data temporary storing area. The CPU 2 fetches a command from the mask ROM 10 or the flash memory 6, decodes the fetched command and, on the basis of a result of the decoding, performs operand fetch and data computation. The coprocessor 7 is a processor unit for performing a remainder multiplying process in RSA or elliptic curve cryptosystem for the CPU 2. The I/O port 12 has 2-bit input/output terminals I/O1 and I/O2 which are also used for inputting/outputting data and inputting an external interrupt signal. The I/O port 12 is coupled to the data bus 13. To the data bus 13, the CPU 2, RAM 4, timer 5, flash memory 6, mask ROM 10, and coprocessor 7 are connected. The system control logic 11 performs control of the operation mode of the microcomputer 1 and interruption control and, further, has a random number generation logic used for generation of a cipher key. /RES denotes a reset signal for the microcomputer 1. When resetting operation is instructed by the reset signal /RES, the microcomputer 1 is internally initialized, and the CPU 2 starts executing the operation program from the leading address. The clock generator 9 receives an external clock signal CLK and generates an internal clock signal CK. The microcomputer 1 operates synchronously with the internal clock signal CK.

The flash memory 6 is assigned as a data storing area and a program storing area. The data storing area in the flash memory 6 is used for storing a cipher key, ID information, and the like. The flash memory 6 inputs/outputs data from/to the data bus 13, for example, on the byte unit basis. The erasing/writing unit in the flash memory 6 is a page unit in both the data storing area and the program storing area. The erasing/writing operation on the page unit basis is performed, for example, in the unit of page data of 256 bytes and in the unit of a plurality of memory cells on a word line unit basis including the amount of a page data status of four bits which will be described later. Therefore, also in the case of rewriting 8-bit data, the erasing/writing operation has to be performed on the page unit basis. For the data storing area in the flash memory 6 which is expected to be frequently rewritten on a system, a backup is considered so that data other than 8-bit data to be rewritten in data of a page to be erased or rewritten is not lost even when the power source is shut off during the rewriting operation. The data storing area is different from the program storing area which is rewritten by the manufacturer of the microcomputer. To obtain necessary data processing speed, the speed of the operation of erasing/writing data from/to the data storing area in the flash memory 6 has to be high. On the other hand, the backup should not be the cause of long time of the erasing/writing operation on the data area. The flash memory 6 can obtain the same effect as that of the backup without requiring additional time on the data storing area which is expected to be rewritten frequently.

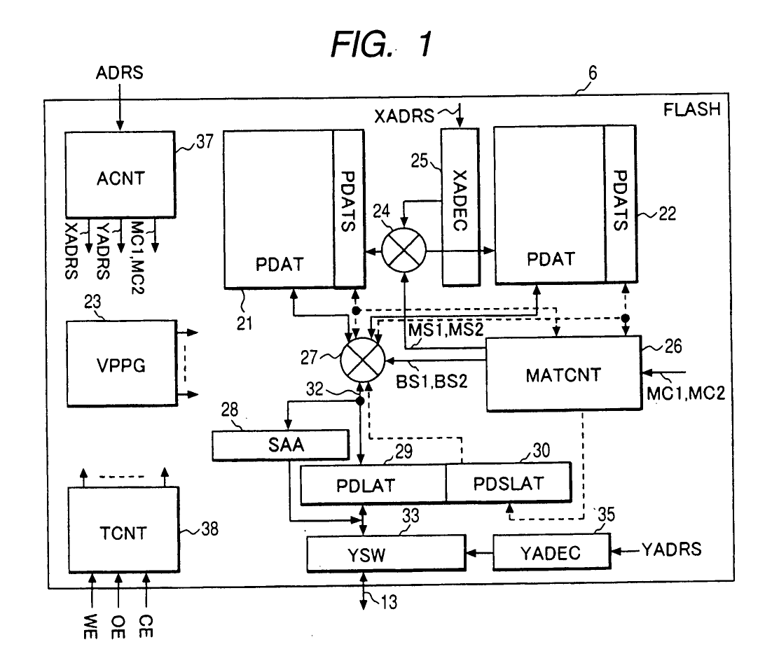

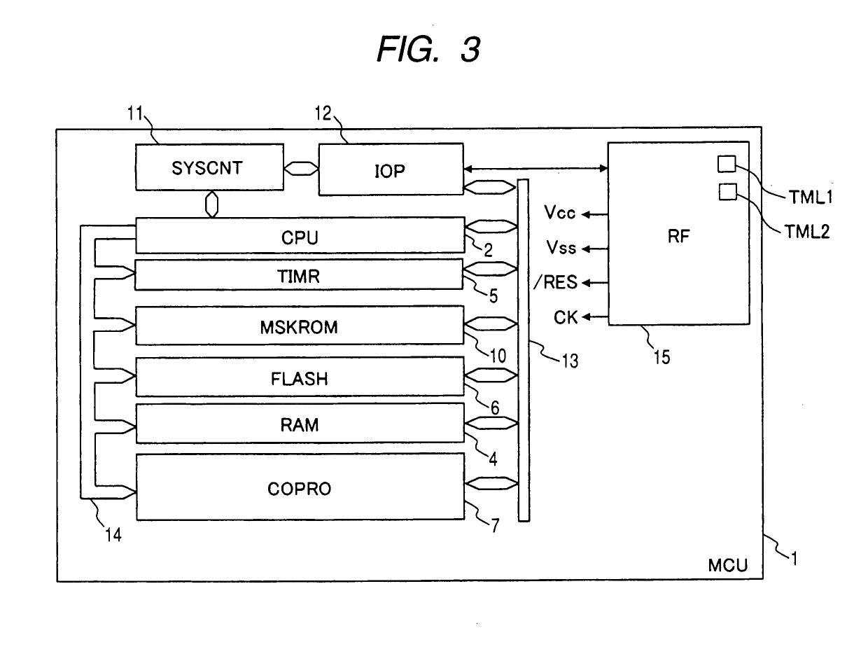

FIG. 3 shows another example of the microcomputer 1. The microcomputer 1 illustrated in FIG. 3 is different from the microcomputer in FIG. 1 with respect to external interface means. Specifically, the microcomputer of FIG. 3 includes a radio frequency (RF) unit 15 having antenna terminals TML1 and TML2 which can be connected to a not-shown antenna. The RF unit 15 uses, as an operation power supply, an induced current generated when the antenna crosses a predetermined electric wave (for, example, microwave), outputs a power supply voltage Vcc, generates the reset signal RES and the clock signal CK, and inputs/outputs information from/to the antenna in a non-contact manner. The I/O port 12 transmits/receives information to be input/output from/to the outside to/from the RF unit 15. In particular, in the case of performing a security process via a non-contact interface, rewriting of the flash memory 6 and the like has to be performed within the limited time of the non-contact interface, so that increase in the speed of the data writing operation is requested.

Flash Memory

FIG. 1 shows an example of the flash memory 6. The flash memory 6 has, for example, two memory mats 21 and 22. Each of the memory mats 21 and 22 has a plurality of nonvolatile memory cells arranged in a matrix in a well region. The nonvolatile memory cell has a so-called MONOS structure in which a charge accumulation layer made of silicon nitride or the like and a memory gate are stacked via an insulating film over a change formation region between the source and the drain. The memory gates of nonvolatile memory cells arranged in the same row are connected to corresponding word lines, and the drains of the nonvolatile memory cells arranged in the same row are connected to corresponding bit lines. The source of the nonvolatile memory cell is connected to the source line. Since the erasing/writing operation is performed on the page unit basis, well regions are not isolated at least in the range of one page in the word line direction. The bit lines of the number corresponding to, for example, the number of nonvolatile memory cells of one page exist. The storage area of each page is constructed by a page data area (PDAT) and a page data status area (PDATS). Although not limited, the page data area (PDAT) is made of 256 bytes, and the page data status area (PDATS) is made of “i” bits.

In the erasing operation, for example, to the well region in one of the two memory mats 21 and 22 determined by mat selection signals MS1 and MS2 generated by a mat control circuit (MATCNT) 26, a well voltage of 1.5V is applied as an erase voltage. A memory gate voltage of −8.5V is applied as an erase voltage to a word line to be erased. A memory gate voltage of 1.5V is applied as an erase stopping voltage to a word line which is not to be erased. All of bit lines and source lines are set to 1.5V. As a result, an electric field transmitted from the well region to the memory gate electrode of a memory cell to be erased is generated. In the memory cells to be erased, electrons captured in a charge accumulation area are released to the well region via an oxide film by FN tunneling, so that the threshold voltages of the memory cells decrease. In the writing operation, for example, to the well region in one of the two memory mats 21 and 22 determined by the mat selection signals MS1 and MS2 generated by the mat control circuit (MATCNT) 26, a well voltage of −10.7V is applied as a write voltage. A memory gate voltage of 1.5V is applied as a write voltage to a word line to be written. A memory gate voltage of −10.7V is applied as a write stopping voltage to a word line which is not to be written. To all of source lines and bit lines connected to nonvolatile memory cells to be selected for writing, a write voltage of −10.7V is applied. To source lines and bit lines connected to nonvolatile memory cells which are not to be selected for writing, 1.5V is applied as a write stopping voltage. As a result, an electric field transmitted from the memory gate electrode to the well region is generated in a nonvolatile memory cell to be written. Electrons from the well region in the memory cell are captured in the charge accumulation area by FN tunneling, so that the threshold voltage of the memory cell is increased. High voltages used for the erasing and writing operations and the like are generated by a voltage generating circuit (VPPG) 23 having a charge pump circuit and the like.

The word lines are selectively driven by a word driver circuit 24. A word line to be driven is determined by an output from an X address decoder (XADEC) 25 and the mat selection signals MS1 and MS2 generated by the mat control circuit (MATCNT) 26.

A bit line of one of the memory mats 21 and 22 is selected via a selector circuit (BLSEL) 27. A bit line corresponding to the page data area among the selected bit lines is connected to a sense amplifier (SAA) 28 and a page data write latch (PDLAT) 29, and a bit line corresponding to the page data status area is connected to a page data status write latch (PDSLAT) 30. Bits of the page data write latch 29 are connected to a data line 32, and the data line 32 is connected so that input/output nodes of the sense amplifier 28 correspond to the bits. The data bus 13 can be connected to the data line 32 on the byte unit basis selected by a Y switch circuit (YSW) 33. The selecting operation on the byte unit basis by the Y switch circuit 33 is controlled by an output of a Y-address decoder (YADEC) 35. To the page data status write latch 30, a page data status for writing is supplied from the mat control circuit 26. The selecting operation of the selector 27 is controlled by mat selection signals MS3 and MS4 output from the mat control circuit 26. The operating mode of the mat control circuit 26 is determined by the mat control signals MC1 and MC2 of two bits and the page data status read from a page to be accessed in the memory mats 21 and 22. The details of the operating mode will be described later.

An address control circuit (ACNT) 37 receives an address signal ADRS output from the host and, in response to the signal, outputs an X-address signal XADR to be supplied to the X-address decoder 25, a Y-address signal YADRS to be supplied to the Y-address decoder 35, and the mat control signals MC1 and MC2. The high-order side in the address signal ADRS is the X-address signal XADR, and the low-order side is the Y-address signal YADRS.

An internal timing control circuit (TCNT) 38 decodes an access command instructed by a combination of control signals supplied from the address and control bus 14, according to the result, generates an internal timing of the erasing operation, writing operation, or reading operation, and controls the operation. The control signals are, for example, a write enable signal WE, an output enable signal OE, and a memory enable signal ME.

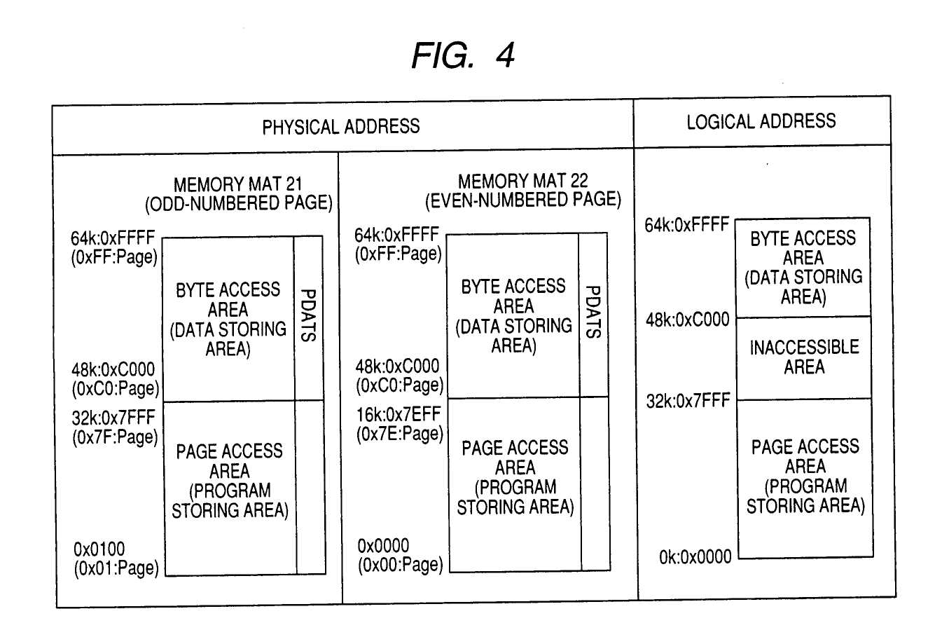

FIG. 4 illustrates an address map of the flash memory 6. An address is indicated in hexadecimal numbers. A logic address of the flash memory is made of 64 Kbytes of 0x0000 to 0xFFFF. To 0x0000 to 0x7FFF, the program storing area is assigned. To 0x8000 to 0xFFFF, the data storing area is assigned. 0x8000 to 0xBFFF is an inaccessible area. For convenience, the data storing area is also called a byte access area, and the program storing area is also called a page access area. An odd-numbered page is assigned to the memory mat 21, and an even-numbered page is assigned to the memory mat 22. The page data status area (PDATS) is significant for the data storing area, and is insignificant for the program storing area.

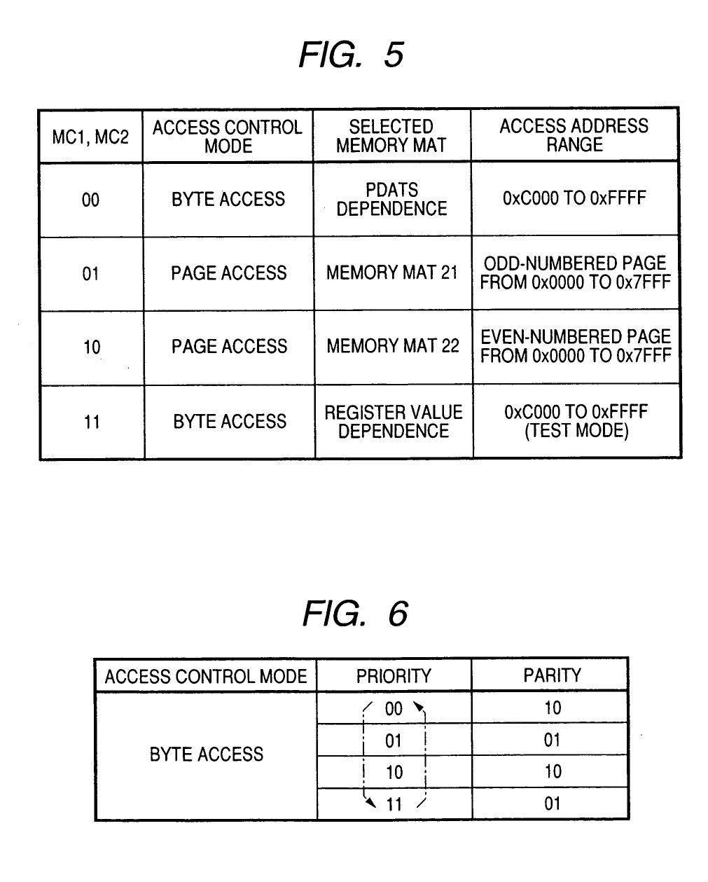

FIG. 5 illustrates significance of the mat control signals MC1 and MC2. The address control circuit 37 determines whether the input address signal ADSRS designates the byte access area or the page access area. When the page access area is designated and the address signal ADSRS indicates the address of an odd-numbered page, the mat control signals MC1 and MC2 are set to 01. In response to the setting, the mat control circuit 26 activates MS1 to allow the word driver circuit 24 to drive the word line of the memory mat 21, and activates BS1 to allow the selector 27 to select connection of the data line 32 to the memory mat 21. It enables an access to the memory mat 21. On the other hand, when the page access area is designated and the address signal ADSRS indicates the address of an even-numbered page, the mat control signals MC1 and MC2 are set to 10. In response to the setting, the mat control circuit 26 activates MS2 to allow the word driver circuit 24 to drive the word line of the memory mat 22, and activates BS2 to allow the selector 27 to select connection of the data line 32 to the memory mat 22. It enables an access to the memory mat 22.

When the byte access area is designated, if the mode is not the test mode, the mat control signals MC1 and MC2 are set to 00. If the mode is the test mode, the mat control signals MC1 and MC2 are set to 11. The test operation is designated by, for example, setting a test mode bit in a not-shown control register. When the mat control signals MC1 and MC2=00, the mat control circuit 26 activates both of the signals MS1 and MS2 and enables the page selecting operation to be performed in both of the memory mats 21 and 22. The mat control circuit 26 receives page data statuses read from both of the memory mats and, according to the page data statuses, allows the selector 27 to connect the data line 32 to the memory mat 21 or 22. In the reading operation, page data read from one of the memory mats selected and made conductive by the selector 27 is sensed and amplified by the sense amplifier 28, and byte data selected by the Y switch circuit 33 in accordance with the Y-address signal YADRS is output to the data bus 13. In the erasing and writing operations, page data read from one of the memory mats selected and made conductive by the selector 27 is latched by the latch 29. The latched page data is merged with byte data input from the bus 13 and selected and supplied by the Y switch circuit 33. The page data status read from one of the memory mats which is conductive to the data line 32 via the selector 27 and supplied to the mat control circuit 26 is updated so that it is understood that the page data status is updated most recently. The updated page data status is loaded to the page data status write latch 30. The updated page data held by the page data latch 29 and the updated page data status held by the page data status latch 30 is written to the other memory mat.

When the mat control signals MC1 and MC2=11 in the test mode, the selecting mode of the selector 27 can be varied according to the value of a control bit of a not-shown control register regardless of the page data status. Therefore, the selecting mode of the selector 27 can be made different from that in the case where the control signals MC1 and MC2 are 00, and backup data can be sent to the outside and verified.

FIG. 6 shows a concrete example of the page data status. The page data status consists of four bits of PDS0, PDS1, PDS2, and PDS3. The bits PDS0 and PDS1 denote priority data indicative of priority, and the bits PDS2 and PDS3 indicate error determination bits. The priority data PDS0 and PDS1 is updated in the order of 00, 01, 10, 11, 00, . . . and the priority increases each time the priority data is updated. When the priority data PDS0 and PDS1 of the selected page of one of the memory mats 21 and 22, selected by the byte access is 00 and the priority data PDS0 and PDS1 of the selected page of the other memory mat is 11, the priority of the priority data of 00 is higher. The error determination bits PD2 and PD3 are used to detect whether power shutoff occurs during the erasing/writing operation or not for the reason that when data destruction occurs due to the power shutoff at the time of page rewriting, all of the plurality of error determination bits PDS2 and PDS3 become the logic value 1 or 0.

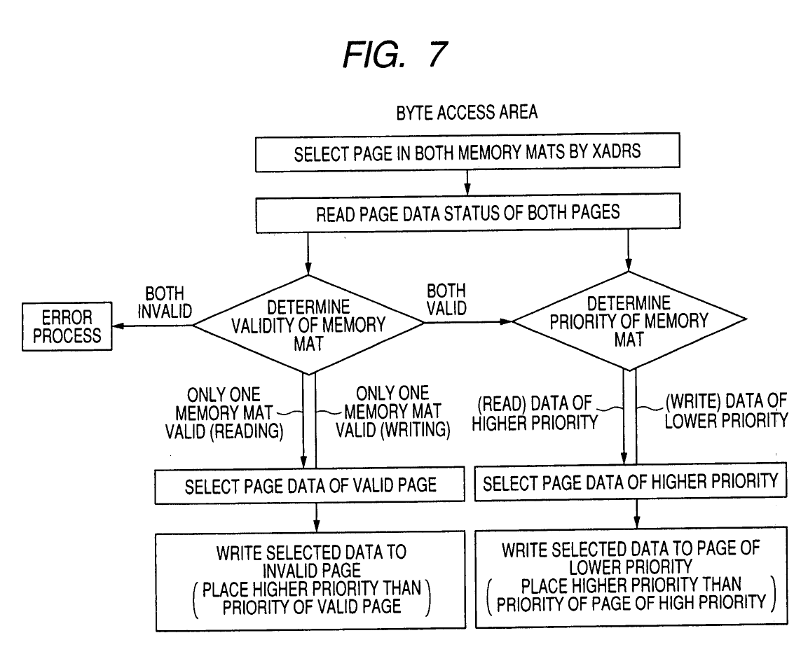

FIG. 7 schematically shows a control mode of the mat control circuit 26 in accordance with the page data status. From the error determination bits PDS2 and PDS3 of the selected page of one of the memory mats 21 and 22 in the byte access and the error determination bits PDS2 and PDS3 of the selected page of the other memory mat, the validity of page data read from both of the memory mats is determined. When the bits PDS2 and PDS3 have the same logic value, the page data is determined as invalid. When both of the pages are invalid, there is no valid data to be read or rewritten, so that an error process is performed. For example, the mat control circuit 26 outputs an error code or a data error interruption to the CPU. The selector 27 is controlled by the signals BS1 and BS2 in such a manner that if one of the pages is valid, the page data of the page is to be read, and at the time of rewriting, the invalid page is set as an object of writing. At the time of rewriting, the mat control circuit 26 latches new priority data obtained by updating each of the priority data PDS0 or PDS1 determined as valid and the error determination bits PDS2 and PDS3 by one grade and parities in the latch 30, and merges the latched data with page data, thereby obtaining rewritten data. When both of the pages are valid, priority of page data is determined by referring to the priority data PDS0 and PDS1. The selector 27 is controlled by the signals BS1 and BS2 to select page data having higher priority in page data read from both of the memory mats so that the selected signal is transmitted to the data line 32. At the time of writing, the selector 27 is controlled by the signals BS1 and BS2 to write data to the page of the memory mat storing the page data having lower priority. At the time of writing, the mat control circuit 26 latches new priority data obtained by updating the priority data PDS0 and PDS1 of the page having higher priority and the error determination bits PDS2 and PDS3 by one grade and parities in the latch 30, and merges the latched data with page data, thereby obtaining rewritten data.

As a result, in the operation of writing data to the byte access area, data other than a byte to be rewritten is held as it is in the most-recently-rewritten valid page selected in one memory mat, and page data obtained by updating a byte to be rewritten is newly written to a selected page in the other memory mat. Therefore, the selected page in one memory mat has substantial backup data which has not been subjected to the rewriting for the selected and rewritten page in the other memory mat. Even if the power is shut off during the erasing/writing operation on a memory mat, data to be written in this operation is not lost but remains in a corresponding page in the other memory mat. It is unnecessary to additionally perform another access operation for transferring data to another area for backup.

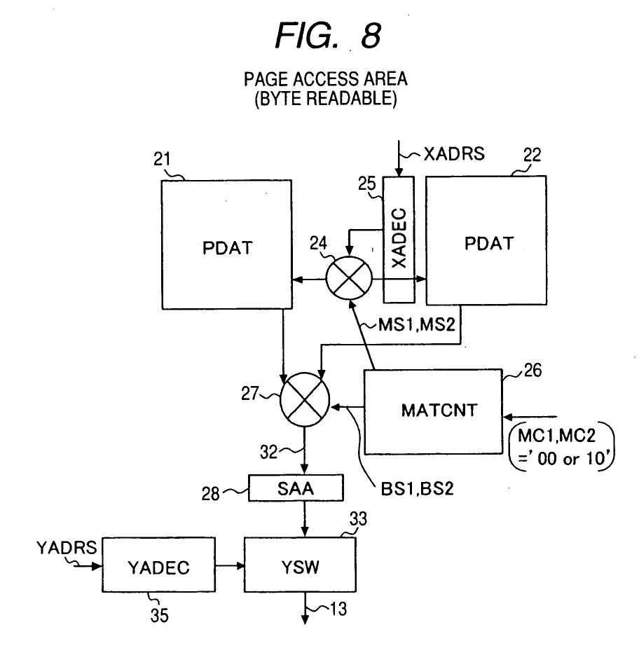

FIG. 8 shows the flow of data in the byte reading operation on the page access area. The signals MC1 and MC2 are set to 01 or 10. The mat control circuit 26 selectively controls the word driver circuit 24 and the selector 27 in accordance with the values of the signals MC1 and MC2. In the case of a page access with MC1 and MC2=01, a word line in the memory mat 21 is driven and a page is selected in accordance with the X address signal XADRS. The selected page data is sensed and amplified by the sense amplifier 28. The Y switch circuit 33 selects byte data on the basis of the Y address signal YADRS from the page data held in the sense amplifier 28, and the selected byte data is output to the data bus 13. In the case of a page access with MC1 and MC2=10, a word line in the memory mat 22 is driven and byte data is read similarly.

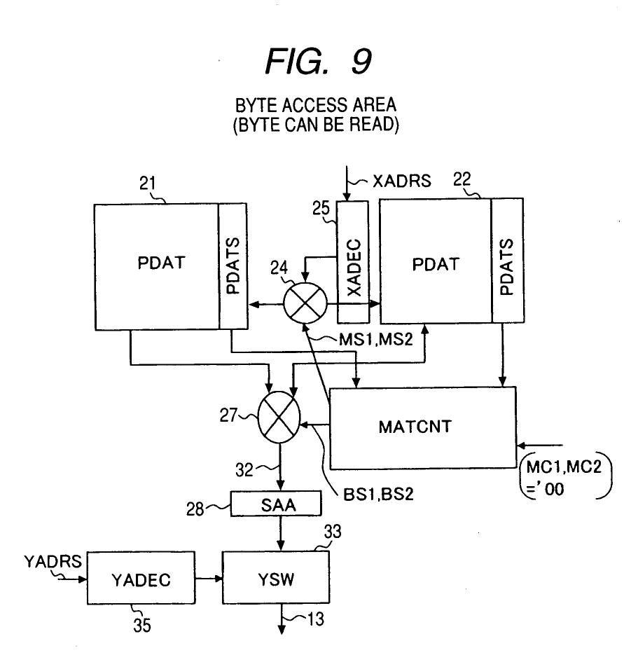

FIG. 9 shows the flow of data in the byte reading operation on the byte access area. The signals MC1 and MC2 are set to 00. The X-address decoder 25 generates a word line selection signal in accordance with the X-address signal XADRS. The mat control circuit 26 drives a word line in accordance with the word line selection signal in both of the memory mats 21 and 22 via the word driver circuit 24, and obtains page data statuses of pages selected by both of the memory mats 21 and 22. The mat control circuit 26 determines validity of the pages on the basis of the page data statuses of both of the pages. According to the control mode described with reference to FIG. 7, for example, when only one of the pages is valid, the page data of the valid page is selected by the selector 27. When both of the pages are valid, the page data of the page having higher priority is selected by the selector 27. When both of the pages are invalid, an error process is notified. The page data selected by the selector 27 is sensed and amplified by the sense amplifier 28. The Y switch circuit 33 selects byte data on the basis of the Y-address signal YADRS from the page data held in the sense amplifier 28, and the selected byte data is output to the data bus 13.

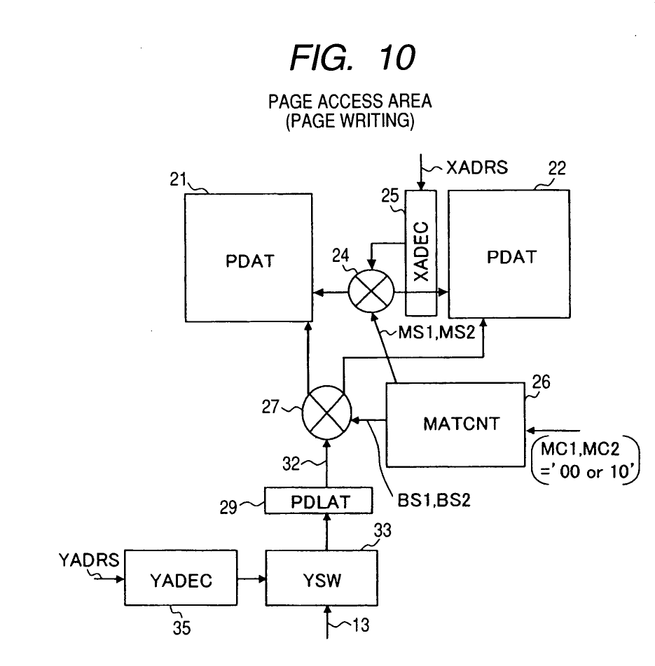

FIG. 10 shows the flow of data in the page writing operation on the page access area. The Y switch circuit 33 selects a data line in bytes on the basis of the Y-address signal. YADRS. When write byte data is sequentially input from the data bus 13 synchronously with increment of the Y address signal YADRS, the write data in bytes is latched from the low-order side toward the high-order side by the write data latch 29. The signals MC1 and MC2 are set to 01 or 10, and the mat control circuit 26 connects the data line to the memory mat 21 or 22 in accordance with the values of the signals MC1 and MC2, and selectively drives the word driver circuit 24 in accordance with the values of the signals MC1 and MC2. As a result, in the case of the page access with MC1 and MC2=01, data of one page is written to the page selected by the memory mat 21. In this example, the write data is a program.

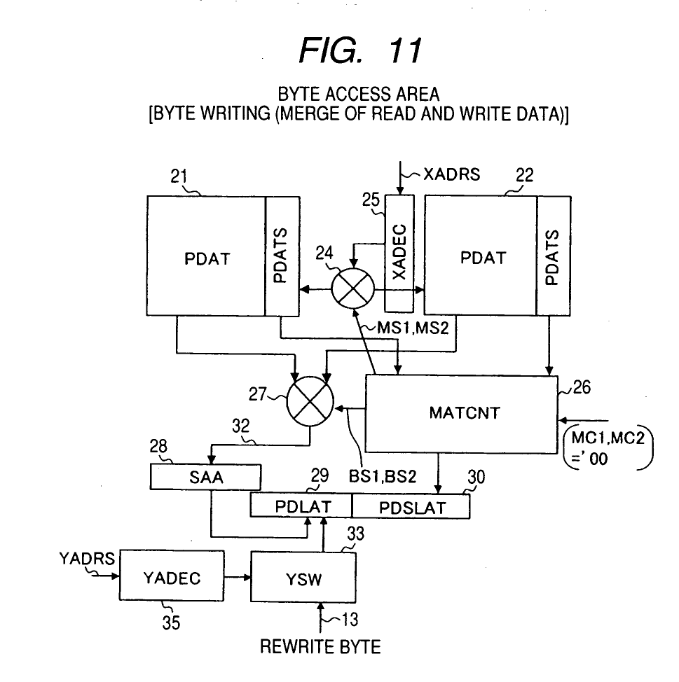

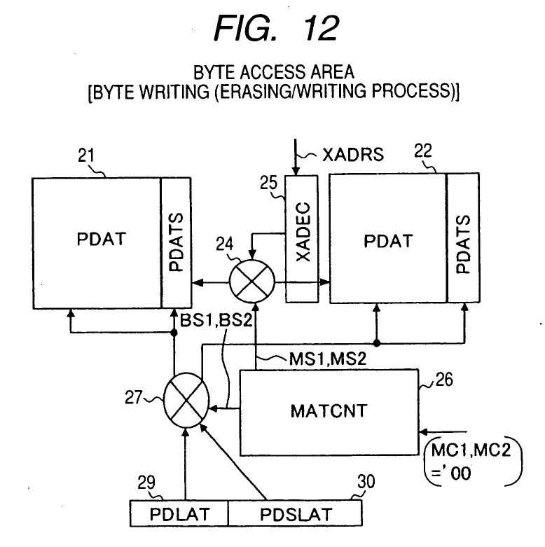

FIGS. 11 and 12 show the flows of data in the byte rewriting operation on the byte access area. Specifically, FIG. 11 shows the flow of data in the data reading operation for merging page data to be rewritten with write byte data. FIG. 12 shows the flow of data in the operation of writing the merged page data. The signals MC1 and MC2 are set to 00. In FIG. 11, the X-address decoder 25 generates a word line selection signal in accordance with the X-address signal XADRS. The mat control circuit 26 drives a word line in accordance with the word line selection signal in both of the memory mats 21 and 22 via the word driver circuit 24, and obtains the page data statuses selected by both of the memory mats 21 and 22. The mat control circuit 26 determines the validity of page from the page data statuses of both of the pages. According to the control mode described with reference to FIG. 7, for example, when only one of the pages is valid, the page data of the valid page is selected by the selector 27. When both of the pages are valid, the page data of the page having higher priority is selected by the selector 27. When both of the pages are invalid, an error process is notified. The page data selected by the selector 27 is sensed and amplified by the sense amplifier 28. The page data held in the sense amplifier 28 is internally transferred to the page data write latch 29. To the page data write latch 29, write byte data supplied from the data bus 13 is supplied via the Y switch circuit 33. The position of the supplied byte data is selected in the Y switch circuit 22 by the Y address signal YADRS. On the page data write latch 29, the page data having higher priority is merged with the write byte data. In the page data status write latch 30, a new page data status to be written with the merged page data is prepared by the mat control circuit 26. The page data status prepared has priority higher than that of the page data latched in the page data write latch 29 or has a parity different from that of the page data latched in the page data write latch 29.

After the page data to be written is prepared, an erasing process and a writing process on the write page are performed by using the data paths shown in FIG. 12. Specifically, the mat control circuit 26 performs the erasing and writing operation on a corresponding page in the memory mat on the side opposite to the page of data loaded to the page data write latch 29. The rule is as described in FIG. 7, and a page having lower priority is set as an invalid page. First, the erasing process is performed on the page to be erased or written in a lump. To the page to be erased/written in the corresponding memory mat, the data held in the page data write latch 29 and the page data status write latch 30 is supplied via the selector 27. The timing control on the erasing and writing processes is performed by the timing control circuit 38.

As obvious from the byte rewriting operation on the byte access area shown in FIGS. 11 and 12, when both of the pages selected by the memory mats 21 and 22 are valid, data other than byte data to be rewritten is held as it is in the valid page having higher priority in the pages, and the page data obtained by updating the byte data to be rewritten is newly written in the page of lower priority. Therefore, the selected page in one memory mat has substantial backup data which has not been subjected to the rewriting for the selected and rewritten page in the other memory mat. Even if the power is shut off during the erasing/writing operation on a memory mat, data which is not to be written in this operation is not lost but remains in a corresponding page in the other memory mat. When one of pages selected by the memory mats is invalid, data other than a byte to be rewritten is held in the valid page, and page data obtained by updating a byte to be rewritten is newly written to a page which is initially invalid. Therefore, the one page which is initially valid has substantial backup data which has not been subjected to the rewriting for the initially-invalid page to be written. Even if the power is shut off during the erasing/writing operation on a memory mat, data which is not to be written in this operation is not lost but remains in the initially-valid page. Therefore, it is unnecessary to additionally perform another access operation for transferring data to another area for backup. The invention consequently contributes to increase the speed of the data process accompanying the byte rewriting operation on the flash memory 6 in the microcomputer 1 for an IC card. Naturally, the nonvolatile memory cells in the flash memory 6 do not require division of the well region into bytes, so that the occupation area of the flash memory 6 can be reduced by approximately 40%. When the data area (byte access area) is about the half of the program area (page access area), the substantial storage capacity of the data area is about the half of the program area. Generally, the occupation area in the unit storage capacity decreases.

Although not shown, in the case where MC1 and MC2=11 in the test mode, in the byte access operation on the byte access area, when both of the selected pages are valid, selection of a page to be read and selected does not depend on the page data status but depends on the value of a predetermined control bit in a not-shown control register. Therefore, in the test mode, by setting the value of a predetermined control bit in the control register to a first value, operation similar to that in the case where the signals MC1 and MC2=00 can be performed. By setting the value of a predetermined control bit in the control register to a second value, page data on the backup side can be read and whether backup of data is normally performed or not can be verified.

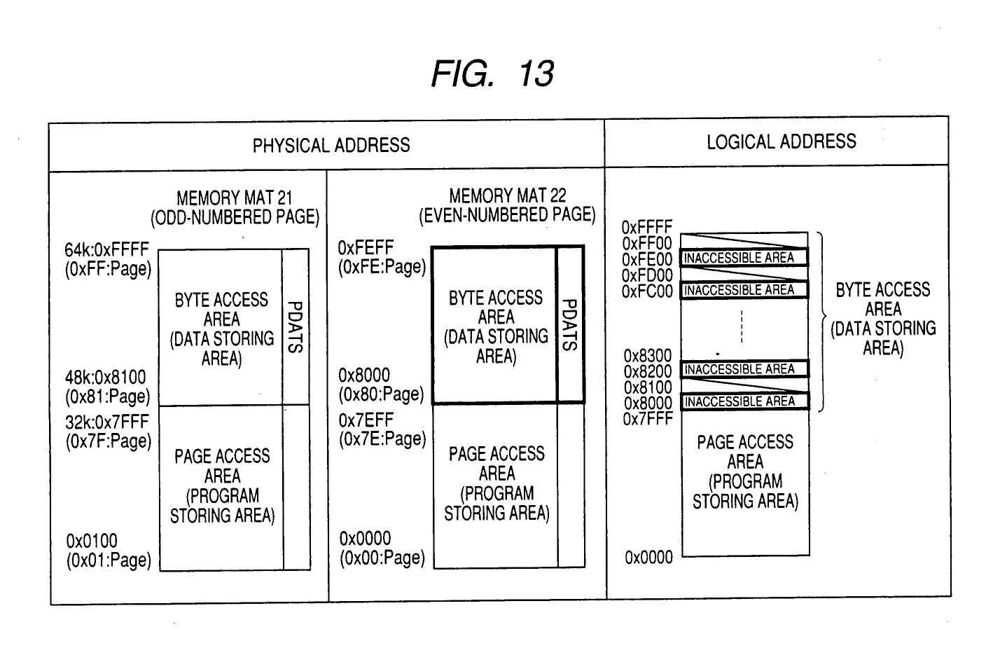

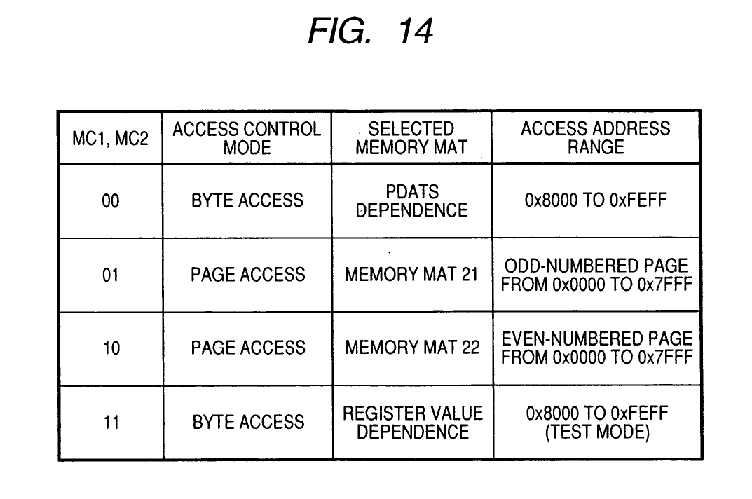

FIG. 13 shows another example of the address map of the flash memory 6. In a manner similar to FIG. 4, an address is indicated in hexadecimal numbers. A logic address of the flash memory is 64 Kbytes of 0x0000 to 0xFFFF. To 0x0000 to 0x7FFF, the program storing area is assigned. To 0x8000 to 0xFFFF, the data storing area is assigned. The different point is mapping of an inaccessible area in the byte access area. Although the linear space from 0x8000 to 0xBFFF of the lower half portion is set as an inaccessible area in FIG. 4, the page data area and the inaccessible area of the page size are alternately disposed in FIG. 13. In a manner similar to FIG. 13, an odd-numbered page is assigned to the memory mat 21, and an even-numbered page is assigned to the memory mat 22. FIG. 14 illustrates significance of the mat control signals MC1 and MC2 corresponding to the address map of FIG. 13. The access address range is different from that of FIG. 5.

In the case of dividing the byte access area into the inaccessible area and the accessible area like in FIGS. 4 and 5, the decoder 25 for decoding the X-address signal XADRS has to have a decode logic for address information which is smaller than a decode logic only for a page access by one bit. Accordingly, the address control circuit 37 has to delete one bit from address bits on the high-order side at the time of extracting the X-address signal XADRS from the access address signal ADRS from the CPU. In the case of arranging the page data areas and the inaccessible page areas alternately in the byte access area as shown in FIGS. 13 and 14, the decode logic of the decoder for decoding the X-address signal XADRS may be the same as the decode logic only for a page address. It is sufficient for the address control circuit 37 to simply extract the X-address signal XADRS from the high-order side of the access address ADRS from the CPU and output the extracted signal. From this viewpoint, by employing the address mapping of FIGS. 13 and 14, a register for setting the data storing area is provided in the address control circuit 37, and the data storing area can be set by rewriting the value of the register.

Although the invention achieved by the inventors herein has been concretely described on the basis of the embodiment, obviously, the invention is not limited to the embodiment but can be variously changed without departing from the gist.

For example, the page size is not limited to 256 bytes, and the byte access is not limited to an 8-bit access but can be properly changed. The number of memory mats is not limited to two but may be four, eight, or the like. A part of the memory mats can be assigned to the byte access control, and the remaining memory mat can be assigned to the page access control. The nonvolatile memory cell is not limited to have the MONOS structure but may have a floating gate structure. Alternatively, a nonvolatile memory cell having a split gate structure can be employed. The array configuration of the memory mat is not limited to the AND configuration but may be another proper array configuration such as NAND or NOR. The error determination bits and the number of bits and bit arrangement of priority data can be properly changed. Although 01 and 10 are alternately used as the error determination bits, one kind of a bit sequence of different logic values like 01 or 10 may be employed as error determination bits. The number of external interface bits of the flash memory is not limited to a byte. The unit such as 2 bytes, 4 bytes, or the like may be used. It is sufficient to extract byte data at the time of performing the byte access control. For the access control from the outside to the nonvolatile memory, a command supplied from the data bus may be used. The invention is not limited to the case where the address control circuit is provided as a part of the functions of the memory control circuit in the flash memory. For example, an MMU (Memory Management Unit), a bus state controller, or a memory controller in the microcomputer may have the function.

The microcomputer to which the invention is applied is not limited to a microcomputer for an IC card. The invention may be applied to a general microcomputer. In this case, the whole nonvolatile memory area may be set as the data storing area or byte access area. In this case, the occupation area of the flash memory in the unit storage capacity does not decrease. However, the control mode of writing data alternately to the two memory mats is employed, so that the upper limit of the number of rewriting times can be almost doubled seemingly, and the life of the rewritable nonvolatile data storing area can be increased. From this viewpoint, the invention can be also applied to a semiconductor processor having a nonvolatile memory in which the program storing area is not set. The semiconductor processor is not limited to the microcomputer but can be widely applied to a semiconductor integrated circuit for performing a data process such as a coprocessor or an accelerator.

What is claimed is:

1. A semiconductor processor comprising a rewritable nonvolatile memory and a data processing unit capable of accessing the nonvolatile memory,
wherein the nonvolatile memory has a plurality of memory mats on which a rewriting operation can be performed on a page unit basis, and a memory control circuit for controlling a storing operation on the memory mats in response to an access instruction from the data processing unit,
wherein the memory control circuit performs a byte access control in response to an access to a predetermined address area in the memory mats and performs a page access control in response to an access to the other address areas, and
wherein the memory control circuit reads control information of each of pages of the plurality of memory mats in the byte access control, determines a page which is rewritten most recently from valid pages on the basis of the read control information, at the time of rewriting data, merges data read from the determined page with write data in a byte unit, writes the resultant data to a corresponding page selected in the other memory mats and, at the time of reading, reads the data from the determined page.

2. The semiconductor processor according to claim 1,
wherein a plurality of error determination bits for indicating whether data of the page is destroyed or not are included as the control information, and
wherein the memory control circuit determines validity of the selected page by the error determination bits of the page.

3. The semiconductor processor according to claim 2, wherein the error determination bits have a combination of a plurality of different logic values.

4. The semiconductor processor according to claim 2, wherein the memory control circuit does not require validity of the corresponding page to which the merged data is written.

5. The semiconductor processor according to claim 4,
wherein priority data of a plurality of bits for indicating priority of data of the page is provided as the control information, and
wherein the control circuit determines that a page corresponding to priority data having the highest priority is a page which is rewritten most recently.

6. The semiconductor processor according to claim 5, wherein at the time of writing the data obtained by merging the byte data, the memory control circuit, updates priority data of a page to be written so as to have priority higher than that of a page having the original data which was merged with the byte data.

7. The semiconductor processor according to claim 1,
wherein the predetermined address area on which the byte access control is to be performed is set as a data storing area, and
wherein the other address area on which the page access control is to be performed is set as a program storing area.

8. The semiconductor processor according to claim 1,
wherein the predetermined address area on which the byte access control is to be performed is set as a first data storing area, and
wherein the other address area on which the page access control is to be performed is set as a second data storing area.

9. The semiconductor processor according to claim 1,
wherein the memory control circuit has an address controller,
wherein the address controller receives an access address signal supplied from the data processing unit and, in response to the received access address signal, generates a page selection address for selecting a page, a byte selection address for selecting a byte in the page, and mat selection control signals of two bits,
wherein the address controller generates a page address common to two memory mats in response to the access address signal designating the page access control, sets the mat selection control signal to a first or second value in accordance with the value of predetermined one bit in the access address signal, generates a page address common to the two memory mats in response to the access address signal designating the byte access control, and sets the mat selection control signal to a third or fourth value on the basis of other control information, and
wherein when the mat selection control signal has the third value, the memory control circuit reads data from a page determined as a page rewritten most recently.

10. The semiconductor processor according to claim 9, wherein the other control information is control information for selectively setting a test mode.

11. The semiconductor processor according to claim 9, wherein when the mat selection control signal has the fourth value, the memory control circuit reads data from a page different from the page determined as a page rewritten most recently.

12. The semiconductor processor according to claim 1, wherein a predetermined address area in a memory mat on which the byte access control is to be performed is an area which is divided to an inaccessible area and an accessible area.

13. The semiconductor processor according to claim 1, wherein a predetermined address area in a memory mat on which the byte access control is to be performed is an area in which inaccessible areas and accessible areas are alternately disposed in each page.

14. A semiconductor processor comprising a rewritable nonvolatile memory and a data processing unit capable of accessing the nonvolatile memory,
wherein the nonvolatile memory has a plurality of memory mats on which a rewriting operation can be performed on a page unit basis, and a memory control circuit capable of performing a byte access control on the memory mats in response to an access instruction from the data processing unit, and
wherein the memory control circuit reads control information of each of pages of a plurality of memory mats in the byte access control, determines a page which is rewritten most recently among valid pages on the basis of the read control information, at the time of rewriting data, merges data read from the determined page with write data in a byte unit, writes the resultant data to a corresponding page selected in the other memory mats and, at the time of reading, reads the data from the determined page.

15. The semiconductor processor according to claim 14,
wherein a plurality of error determination bits for indicating whether data of the page is destroyed or not are included as the control information, and
the memory control circuit determines validity of the selected page on the basis of the error determination bits of the page.

16. The semiconductor processor according to claim 15, wherein the error determination bits have a combination of a plurality of different logic values.

17. The semiconductor processor according to claim 15, wherein the memory control circuit does not require validity of the corresponding page to which the merged data is written.

18. The semiconductor processor according to claim 17,
wherein priority data of a plurality of bits for indicating priority of data of the page is provided as the control information, and
wherein the control circuit determines that a page corresponding to priority data of higher priority is a page which is rewritten most recently.

19. The semiconductor processor according to claim 18, wherein at the time of writing the data merged with the byte data, the memory control circuit updates priority data of a page to be written so as to have priority higher than that of a page having the original data which was merged with the byte data.

20. A semiconductor integrated circuit comprising a rewritable nonvolatile memory,
wherein the nonvolatile memory has a plurality of memory mats on which a rewriting operation can be performed on a page unit basis, and a memory control circuit performing a byte access control on the memory mats in response to an access instruction from the outside, and
wherein the memory control circuit reads control information of each of pages of the plurality of memory mats in the byte access control, determines a page which is rewritten most recently among valid pages on the basis of the read control information, at the time of rewriting data, merges data read from the determined page with write data in a byte unit, writes the resultant data to a corresponding page selected in the other memory mats and, at the time of reading, reads the data from the determined page.

21. A semiconductor integrated circuit comprising a rewritable nonvolatile memory,
wherein the nonvolatile memory has a plurality of memory mats on which a rewriting operation can be performed on a page unit basis, and a memory control circuit performing a byte access control on the memory mats in response to an access instruction from the outside, and
wherein the memory control circuit makes a plurality of memory mats operate in the byte access control, at the time of rewriting data, merges data read from a selected page in one memory mat with write byte data, writes the resultant data to a corresponding page selected in the other memory mats and, at the time of reading, reads the data from the valid page which is most recently rewritten in the selected pages in the plurality of memory mats.
